(19) United States
(12) Patent Application Publication
(10) Pub. No.: US 2012/0131426 A1
(43) Pub. Date: May 24, 2012

(54) DOCUMENT GENERATION AND SERVICES MANAGEMENT

(75) Inventors: Randy E. Oyarzabal, Rochester, MN (US); Jeffery A. Turner, Lexington, KY (US)

(73) Assignee: INTERNATIONAL BUSINESS MACHINES CORPORATION, Armonk, NY (US)

(21) Appl. No.: 12/952,847

(22) Filed: Nov. 23, 2010

(51) Int. Cl. G06F 17/00

(52) U.S. Cl. 715/200

(57) ABSTRACT

Methods, systems and program products for generating a document of understanding. Embodiments of the invention may provide an interface allowing a user to select from a plurality of component documents. Upon receiving a selection of component documents from the user, embodiments may generate a document of understanding based on the received selection. Embodiments may then submit the generated document of understanding for approval, and upon approval, embodiments my mark the generated document of understanding as active.

### BACKGROUND

Embodiments of the invention generally relate to document generation, and more specifically, to techniques for creating and managing a document of understanding.

The creation of a service agreement is typically a complex project involving multiple stakeholders, each with different goals and concerns. Once the stakeholders reach a common agreement regarding various solution components of the project, such an agreement may be memorialized in a document of understanding. However, because each of the stakeholders may wish to modify the document of understanding with proposed amendments before the document is finalized, multiple inconsistent variations of the document may be created. Furthermore, reconciling these different variations of the document is often a time consuming and error prone process. Additionally, many service agreements are for a fixed period of time (e.g., one year), and once a service agreement expires, a new or updated document of understanding may be created to renew the service agreement. Without such updates, the document of understanding may quickly become obsolete and contain various inaccuracies and outdated information. However, such updates are currently a manual process that require a significant amount of time and resources, and are often an error-prone process as well.

### SUMMARY

Embodiments of the invention provide a method, system and program product for creating a document. The method, system and program product include providing an interface allowing a user to select from a plurality of component documents, wherein each component document defines an attribute of the document. Additionally, the method, system and program product include receiving a selection of one or more component documents from the plurality of component documents. The method, system and program product further include generating the document, based at least in part on the received selection of one or more component documents, wherein the document defines an agreement between two entities, and wherein the agreement will go into effect when the document is approved. Also, the method, system and program product include submitting the generated document for approval, and upon approval of the submitted document, marking the document as active to indicate the agreement is in effect.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a diagram illustrating the creation of a document, according to one embodiment of the present invention.

FIG. 2 is a block diagram of components of a computer system configured to run a document creation component, according to one embodiment of the present invention.

FIG. 3 is a block diagram of an exemplary embodiment of the components of FIG. 1, according to one embodiment of the present invention.

FIG. 4 is a flow diagram illustrating a method of creating a master document, according to one embodiment of the present invention.

FIG. 5 is a flow diagram illustrating a method of approving a document, according to one embodiment of the present invention.

FIGS. 6A-6E are screenshots of an exemplary document creation component, according to embodiments of the present invention.

### DETAILED DESCRIPTION

Embodiments of the invention generally provide techniques for generating a document of understanding in a way that improves efficiency of the document generation process and improves the quality of the document. Embodiments of the invention may display an interface including a list of component documents, each defining an attribute of a document of understanding. Embodiments may receive a selection of one or more of the listed component documents, and may generate a document of understanding based on the received selection of one or more component documents. Embodiments may then submit the generated document of understanding for approval and, upon receiving an approval for the document, may mark the document of understanding as active.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., a document creation component) or related data available in the cloud. For example, the document creation component could execute on a computing system in the cloud and allow users to create documents of understanding from a plurality of component documents. In such a case, a document creation component could receive user selections of component documents to include in the document of understanding, generate the document of understanding from the user selections, and store the generated document at a storage location in the cloud. Doing so allows users to access the document of understanding from any computing system attached to a network connected to the cloud (e.g., the Internet).

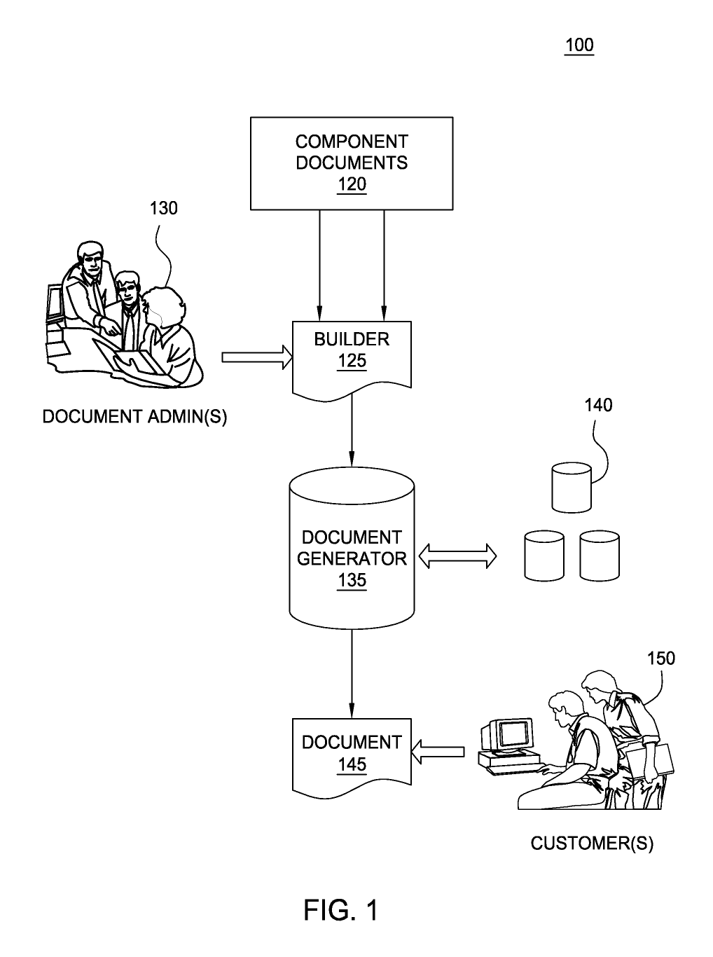

Referring now to FIG. 1, FIG. 1 is a flow diagram illustrating a document creation method, according to one embodiment of the present invention. For purposes of this example, assume that the generated document is a document of understanding related to an exemplary service agreement. As shown, the method 100 begins with the document administrators 130 interacting with the builder 125 to construct an initial document. Generally, the builder 125 may receive selections of components 120 from a user (e.g., the document administrators 130), and may populate each of these selections with data. In one embodiment of the invention, the builder 125 may display a list of available component documents 120 to the user and allow the user to select which component(s) to incorporate in the initial document. Generally, the components 120 define one or more attributes of the document of understanding. For example, the components 120 may include a billing component, which contains billing information related to a particular service offering. If the user selects the billing component, the builder 125 may further prompt the user for the information used to populate the billing component (e.g., an initial cost of the service agreement, a monthly cost of the service agreement, etc.).

Once the selected component 120 is populated, the builder 125 may insert the populated component into the initial document. The document administrators 130 may continue to interact with the builder 125 to add components 120 to the initial document until the initial document is complete. The document administrators 130 may additionally use the builder 125 to arrange the components in the initial document. For example, an initial document may contain two components: a billing component, and a billing component header. In such an example, a document administrator 130 may wish to arrange the components such that the billing component header precedes the billing component itself.

As discussed above, the builder 125 may populate certain information in the initial document based on user input. Additionally, the document generator 135 may also interact with one or more other applications 140 (e.g., a database) in order to populate portions of the final document. For example, the document generator 135 may retrieve updated pricing information from a pricing database 140, and may use the updated pricing information to populate fields in the billing component. In one embodiment of the present invention, the document administrators 130 may use the builder 125 to specify a particular source 140 to retrieve information from. For example, the document administrators 130 may specify that the billing component in the initial document should be populated using a particular database table related to pricing information.

Once all the components 120 have been added to the initial document and once any empty fields in the initial document are populated, the initial document is sent to the document generator 135 to create a final document. As referred to herein, the final document generally refers to the document of understanding generated according to embodiments of the invention. That is, although a first draft of the document of understanding has been created, such a draft may not be marked as active (i.e., will not take effect) until both parties to the document have agreed to its terms. The final document 145 may then be sent to the customers 150 for approval. In one embodiment, rather than sending a separate instance of the document of understanding to the customers 150 for approval, embodiments may send a reference to a single, centralized copy of the document.

Upon receiving the final document 145 (or a reference to the final document), if the customers 150 wish to modify the final document 145, the customers 150 may reject the final document 145 and return the document to the document administrators 130 for revisions. The document administrators 130 may use the builder 125 to revise the components in the initial document, based on the revisions specified by the customer 150. A revised document may then be generated using the document generator 135, and the revised document may be submitted to the customers 150 for approval. Upon approval of the final document 145 (or the revised document), the final document 145 is marked as active and takes effect as the document of understanding for the exemplary service agreement.

Advantageously, by doing this, embodiments of the invention may more efficiently create a document of understanding for a particular project by using existing components 120 and data. For example, an existing solution for adding a billing section to a new document of understanding is to manually create the billing section in the document, research updated pricing data, and manually populate the billing section with the updated pricing data. In contrast, embodiments may more efficiently create the document by adding a billing component from the plurality of components 120 to the initial document, and then automatically populating the billing component with pricing data retrieved from a database 140. By doing this, embodiments of the invention may more efficiently create the document of understanding. Additionally, because embodiments create a single, centralized document of understanding, any revisions made to the document will be incorporated into the centralized copy of the document, thus preventing the creation of multiple inconsistent versions of the document.

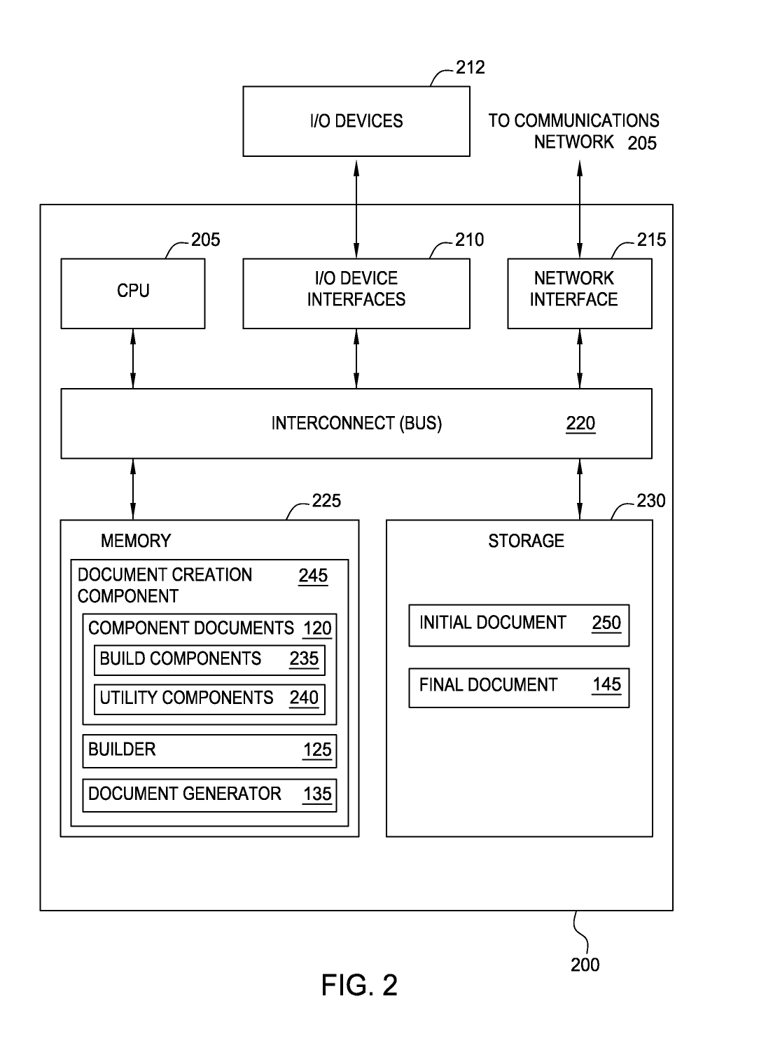

FIG. 2 is a block diagram of components of a computer system configured to run a document creation component, according to one embodiment of the present invention. As shown, the document creation system 200 includes, without limitation, a central processing unit (CPU) 205, a network interface 215, an interconnect 220, a memory 225, and storage 230. The document creation system 200 may also include an I/O devices interface 210 used to connect I/O devices 212 to the compute node 130. I/O devices 212 may represent a variety of input and output devices, including keyboards, mice, visual displays, printers and so on. The document creation system 200 may connect to the network 215 (e.g., the Internet) using the network interface 215.

The CPU 205 retrieves and executes programming instructions stored in the memory 225. Similarly, the CPU 205 stores and retrieves application data residing in the memory 225. The interconnect 220 is used to transmit programming instructions and application data between the CPU 205, I/O devices interface 210, storage 230, network interface 215, and memory 225. CPU 205 is included to be representative of a single CPU, multiple CPUs, a single CPU having multiple processing cores, and the like. Furthermore, CPU 205 may be any processor capable of performing the functions described herein. Although memory 225 is shown as a single entity, memory 225 may include one or more memory devices having blocks of memory associated with physical addresses, such as random access memory (RAM), read only memory (ROM), flash memory or other types of volatile and/or non-volatile memory. Storage 230, such as a hard disk drive, solid state device (SSD), or flash memory storage drive, may store non-volatile data. Furthermore, as will be understood by one of ordinary skill in the art, any computer system capable of performing the functions described herein may be used.

In the pictured embodiment, memory 225 contains a document creation component 245, which in turn contains component documents 120, a builder 125, and a document generator 135. The component documents 120 contain build components 235 and utility components 240. The build components 235 are generally components pertaining to aspects of a service agreement, such as, without limitation, billing, hardware, and services. The utility components 240, on the other hand, are components pertaining to presentation and content of a created document, such as templates and service offerings. Additionally, storage 230 contains an initial document 250 and a final document 145. Furthermore, although various elements are shown as residing in either memory 225 or storage 230, such a depiction is without limitation and is merely for illustrative purposes.

Generally, users (e.g., document administrators) may use the document creation component 245 to create an initial document 250. More specifically, the builder 125 may present the user with a plurality of component documents 120, which may include both build components 235 and utility components 240, and allow users to select particular component documents for inclusion in the initial document 250. Upon receiving a selection of a particular component document 120, the builder 125 may add the selected component document 120 to the initial document 250. Additionally, the builder 125 may prompt the user regarding a placement in the initial document 250 to insert a selected component document 120. For example, if the user has already inserted a header for a billing section into the initial document 250, the user may then specify that a billing section itself should be inserted immediately following the header.

Additionally, the document creation component 245 may prompt the user for data with which to populate the selected component documents 120. For instance, an exemplary build component 235 may be a services component, which contains a list of services to be provided as part of a service agreement. In such an example, the document creation component 245 may prompt the user for which particular services should be included in the initial document 250. For example, a particular service agreement may include basic support services for an initial period of time, and may then include premium support services thereafter. In such a situation, the user may add two different service components to the initial document 250: one service component for the basic support service and a second service component for the premium support service. Additionally, the document creation component 245 may prompt the user for metadata about the provided services. For example, the metadata may include, without limitation, information about the service components such as when each service begins, a duration for each service, etc.

Once the user finishes adding component documents 120 to the initial document 250, the document generator 135 may generate a final document of understanding 145, based on the initial document 250. The document generator 135 may generate the final document 145 using a utility component 240 (e.g., such as a template). For example, the final document 145 may contain a billing section that includes a table detailing pricing information related to the service agreement. In such an example, the document generator 135 may generate the table with particular formatting specified by a particular utility component 240, such as a table template.

Additionally, the document generator 135 may query other applications (e.g., a database accessible over the communications network 205) and retrieve data for use in populating portions of the final document 145. For example, an exemplary initial document 250 may contain a billing section for a particular service agreement. In such an example, the document generator 135 may retrieve updated pricing information pertaining to the service agreement from an external database, and may populate a corresponding section of the final document 145 based on the retrieved pricing information. By doing this, embodiments of the invention may save the user from having to expend time and effort in manually retrieving the updated pricing information when creating a document of understanding. Furthermore, by retrieving updated information at the time the final document 145 is created, embodiments help to ensure the accuracy of information in the created document of understanding.

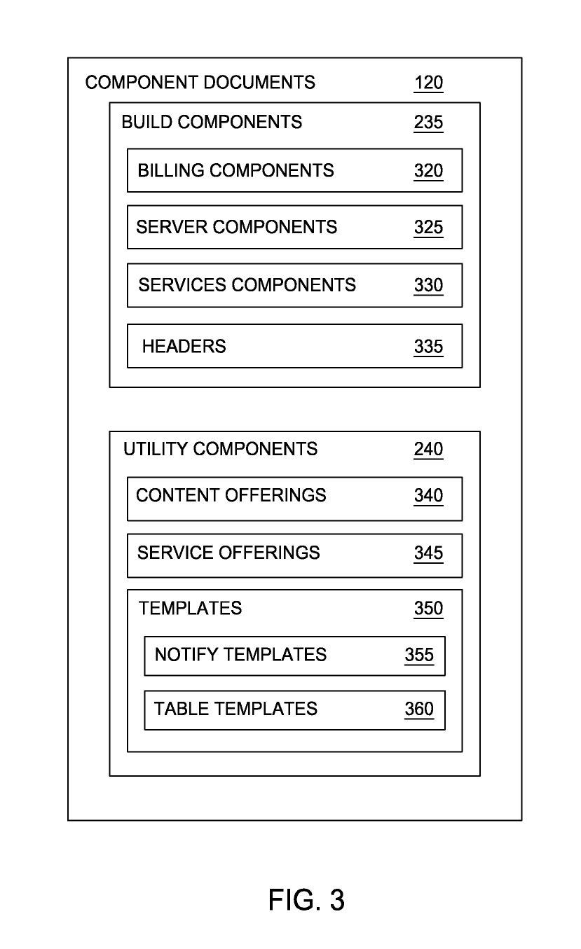

FIG. 3 is a block diagram of an exemplary embodiment of the components of FIG. 1, according to one embodiment of the present invention. As shown, the components 120 contain build components 235 and utility components 240. The build components 235 contain billing components 320, server components 325, services components 330, and headers 335. The billing components 320 generally relate to any billing structure involved in a service agreement including, but not limited to, fixed costs, recurring costs (e.g., monthly costs), and per-use costs. The server components 325 may relate to any server hardware provided as part of the service agreement. Such server hardware may include, without limitation, standalone computer systems, clustered computer systems, virtual computer systems, and cloud computer systems. The services components 330 generally relate to any services to be provided as part of the service agreement. For example, a service component 330 may specify a type of customer support (e.g., basic support, premium support, etc.) provided as part of the service agreement. As a second example, an exemplary service component 330 may specify computing services, such as web hosting, database access, shell access, etc., to be provided as part of the service agreement. The headers 335 generally include section headers for use in the created document of understanding.

As discussed above, the utility components 240 generally contain components used in creating the document of understanding. The utility components 240 contain content offerings 340, service offerings 345, and templates 350. Content offerings 340 generally include content that may be inserted into the document of understanding. For example, content offerings 340 may include, without limitation, formatted text such as assumptions of the service agreement, the terms agreed to, legal form language (e.g., a disclaimer), graphics (e.g., a company logo), and links (e.g., a hyperlink to a company's webpage). In one embodiment, content offerings 340 further contains multimedia content, such as audio content, video content, and animated content. Of course, these examples are for illustrative purposes only, and are without limitation. Furthermore, one of ordinary skill in the art will quickly understand that content offerings 340 may include combinations of these and other content types as well. For example, the content offerings 340 may include an interactive animation containing formatted text that, when accessed by a user, links to a particular webpage.

Additionally, the service offerings 345 may include potential services that may be offered as part of the service agreement. As an example, a particular business may potentially offer both web hosting and database services, which may be reflected in the corresponding service offerings 345 for the particular business. In constructing an initial document 250, the builder 125 may reference these potential service offerings 345 and present them to a user for selection (e.g., using a user interface). If the user then selects the web hosting service, the builder 125 may insert a corresponding service component 330 into the initial document, based on the user's selection.

The content creation component 245 may also use templates in constructing the final document 145. In the depicted example, the templates 350 contain notify templates 355 and table templates 360. The notify templates 355 generally relate to the presentation of any notifications associated with the document creation component 245. For instance, once a final document 145 is created, the document creation component 245 may submit the final document 145 to a customer for approval. As discussed above, in one embodiment, the document creation component 245 sends a reference to a single, centralized copy of the final document 145 to the customer for approval, rather than a separate instance of the final document 145.

In one embodiment, the document creation component 245 may submit the final document 145 to the customer using electronic correspondence, such as email. In such an embodiment, a document administrator may specify a particular notify template 355 during the creation of the document, and once the final document 145 is complete, the document creation component 245 may generate an email to the customer using a specified notify template 355 and containing a reference to the final document 145. As a second example, once the customer either rejects or approves the final document 145, the document creation component 245 may generate a corresponding notification to the document administrator using a notify template 355.

The table templates 360 may be used for generating tables related to the final document 145. Generally, a table template 360 may contain formatting information for use in the creation of a table. Without limitation, such formatting information may include fonts, margins, borders, shading, and so on. Additionally, different tables in the final document 145 may be generated using different table templates 360. Furthermore, although the table templates 360 may be used for the creation of tables in the final document 145, the table templates 360 may also be used for other tables, such as a table included in a notification. For example, a notification sent to a customer upon completion of the final document may contain a table including information on the service agreement (e.g., a response data, contact information, etc.), and such a table may be generated using a particular table template 360.

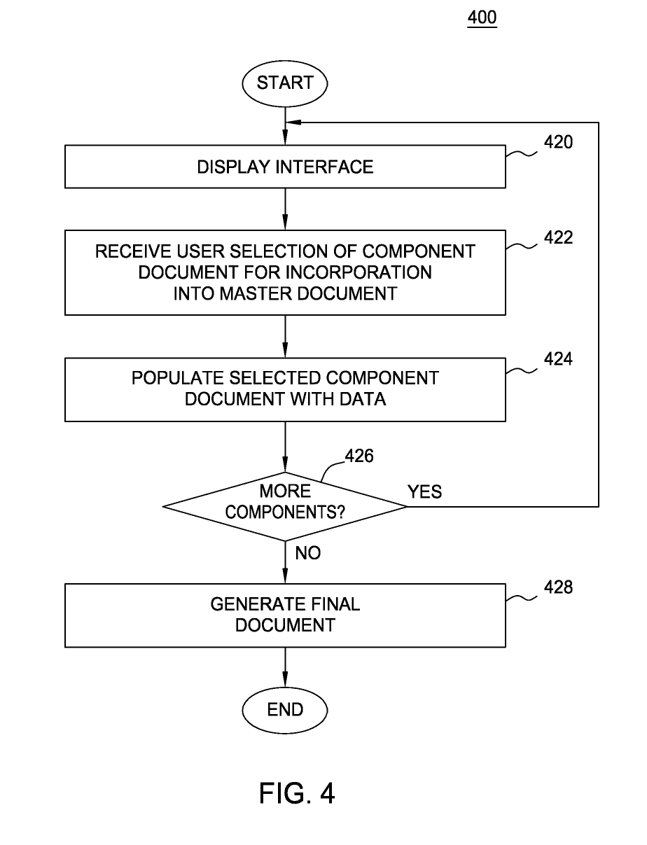

FIG. 4 is a flow diagram illustrating a method of creating a master document, according to one embodiment of the present invention. As shown, the method 400 begins at step 420, where the document creation component 245 generates an interface for display to a user (e.g., using an I/O device 212, such as a monitor). The displayed interface may generally contain component documents 120 that may be inserted into an initial document 250. For example, the interface may contain a listing of available content offerings 340 and service offerings 345. The document creation component 245 then receives a user selection of a component document 120 for incorporation into the initial document 250 (step 422).

Once the document creation component 245 receives the user selection of a component document 120, the document creation component 245 populates the selected component document with data (step 424). As discussed above, the document creation component 245 may populate the component document with data retrieved from an external source (e.g., a database). Additionally, the document creation component 245 may further prompt the user for additional information, and may populate the component document 120 using the additional information specified by the user.

The document creation component 245 then determines whether the user wishes to add more components to the initial document 250 (step 426). In one embodiment, the document creation component 245 assumes that the user wishes to continue adding component documents to the initial document 250 until the user indicates otherwise (e.g., clicking a “Done” button). In another embodiment, the document creation component 245 may prompt the user to determine whether the user wishes to add another component document 120. If the user indicates he wishes to add another component document 120, the method begins again at step 420, where the document creation component 245 displays an interface containing component documents 120 that may be inserted into the initial document 250.

If, instead, the user indicates he does not wish to add any more component documents, the document creation component 245 generates the final document 145 based on the initial document 250 (step 428). Additionally, the final document 145 may be generated using one or more templates 350. For example, the document creation component 245 may determine the formatting for a particular table in the final document 145 using a table template 360 specified in the corresponding initial document 250. In one embodiment, the document creation component 245 may use a default table template 360 for creating tables in the final document 145, if no table template 360 is specified in the initial document 250. One the final document is generated, the method 400 ends.

Advantageously, the method 400 may create the document of understanding more efficiently than known solutions. For example, rather than recreating the existing component documents 120, the document creation component 245 creates the initial document 250 using a selection of existing component documents 120. The method 400 also improves the efficiency of the document creation by automatically formatting content in the final document 145 based on the templates 350. For example, a particular pricing structure in the final document 145 may include a table containing various pricing information. The appearance of such a table may be modified by adjusting formatting elements such as borders, cell shading, font style, font size, text alignment, and so on. However, rather than having the user manually adjust each of these elements for the table, the method 400 allows the user to simply specify a table template 360 for use in the creation of the table. As such, the method 400 more efficiently creates the final document 145. Furthermore, the component documents 120 may be automatically populated with information from an external source (e.g., a database). This may result in a substantial time savings for the user, as the user may avoid manually locating and retrieving the external information.

As an additional advantage, by automatically populating the components 120 with up-to-date information from an external source, the method 400 improves the quality of the document of understanding by ensuring that current information is used in the creation of the document. For example, the prices of particular services and hardware offered by a business may be frequently updated based on current market value. By automatically retrieving the most up-to-date prices when the final document is created 145, the method 400 ensures that the final document 145 contains accurate pricing information.

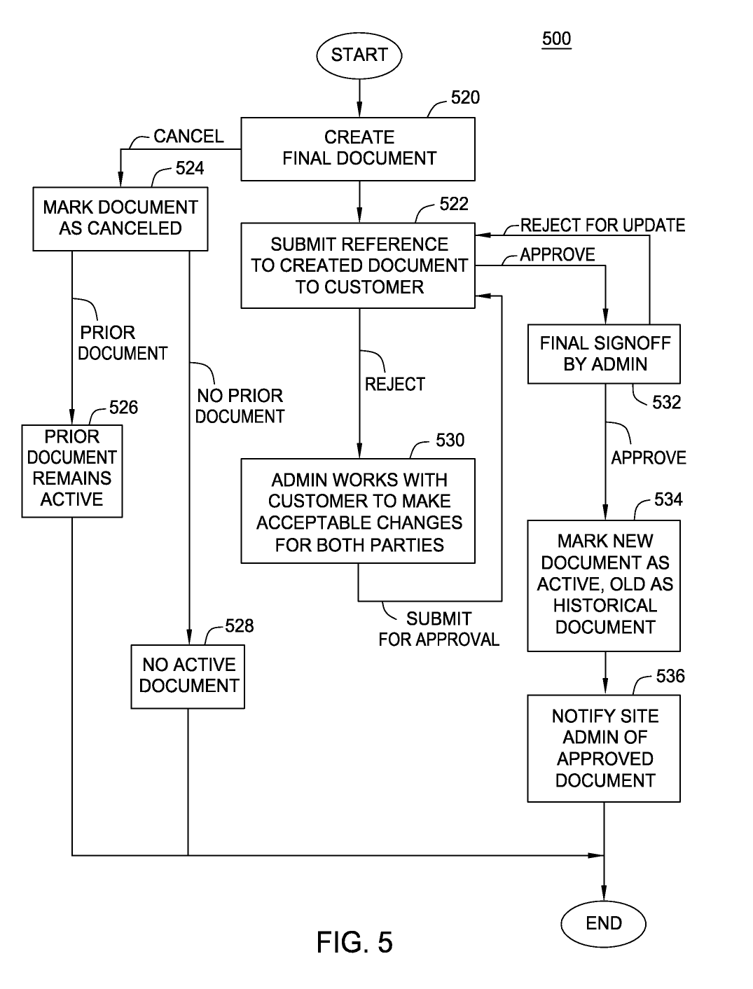

FIG. 5 is a flow diagram illustrating a method of approving a document, according to one embodiment of the present invention. For the purposes of this example, assume that the final document is created by a business, and that the final document represents a document of understanding between the business and a customer. As shown, the method 500 begins at step 520, where the document creation component 245 creates a final document 145. In one embodiment of the invention, the document creation component 245 creates the final document 145 by using the method 400, as discussed above. Once the final document 145 is created, the document creation component 245 submits a reference to the final document 145 to the customer for approval (step 522). That is, in the method 500, the document creation component 245 maintains a single, centralized copy of the final document 145, and rather than sending a separate instance of the final document 145 to the customer, the document creation component 245 sends a reference to the single instance of the final document 145.

Upon receiving the reference to the final document 145, the customer may take one of several courses of action. For instance, the customer may reject the final document 145, whereby a document administrator from the business works with the customer to make acceptable changes to the final document 145 (step 530). For example, a first draft of the final document 145 may specify that the business will provide computer hardware with 12 gigabytes of memory. However, after reviewing the pricing information in the final document 145, the customer may reject the first draft of the final document 145 and request only 8 gigabytes of memory (along with a corresponding reduced price). Once the document administrator for the business updates the final document 145, the method returns to step 522, where the document is again submitted to the customer for approval.

Additionally, upon receiving reference to the final document 145 from the business, the customer may approve of the final document 145. In one embodiment, upon receiving the approval from the customer, the document creation component 245 may generate a notification to a document administrator. For instance, such a notification may be generated based on a particular notify template 355. Once the customer approves of the final document 145, the document administrator is prompted for a final signoff on the final document 145 (step 532). If the administrator rejects the final document 145, the administrator may revise the final document 145. For example, when reviewing the final document 145 for a final approval, the document administrator may notice an oversight in the document, and accordingly reject the final document 145 to correct the oversight. The method then returns to step 522, where the document is again submitted to the customer for approval.

If instead the administrator approves the final document 145, the final document 145 is marked as an active document of understanding between the business and the customer (step 534). Additionally, any previously active document of understanding for the same service agreement is marked as an inactive historical document at this point. That is, because the final document 145 replaces the previously active document of understanding, the previously active document is marked as inactive. Once the final document is marked as active, the document creation component 245 notifies the document administrator accordingly (step 536). As discussed above, such a notification may be generated using a notify template 355. For instance, the document creation component 245 may contain settings that allow document administrator to configure default notify templates 355 for use in notifications the document creation component 245 sends. As an example, a document administrator may configure the document creation component 245 so that notifications sent when a customer rejects a document use a first template, and notifications sent when a customer accepts a document use a second, different template. Additionally, in such an embodiment, the settings may allow the document administrator to configure a specific notify template 355 for use with particular notifications the document creation component 245 sends.

On the other hand, upon receiving the reference to the final 145 document, the customer may decide to cancel the service agreement altogether. In this scenario, the document creation component 245 marks the final document as cancelled (step 524). If a prior document of understanding exists and is already active, the prior document of understanding remains active (step 526), and the method 500 ends. For example, the final document 145 in the method 500 may represent a revised version of an existing service agreement between the business and the customer and the final document 145, if approved, would replace the existing, active service agreement between the two. In such an example, upon cancelling the final document 145 (i.e., the revised version of the service agreement), the previous existing service agreement between the business and the customer would remain in effect. If instead no prior document of understanding exists, or if the existing prior document was not active, then no document will remain active between the business and the customer (step 528), and the method ends.

Advantageously, the method 500 improves the document approval process by maintaining a single, centralized document of understanding. For example, one current solution is to send physical copies of the document to each of the involved parties, and each of these parties may make separate modifications to their instance of the document. However, such a solution is not ideal, as the result may be multiple different variations of the same document, which must then be reconciled with one another to produce a single document of understanding. Such reconciliation may be difficult if, for example, two changes are contradictory with one another. Additionally, such existing solutions increase the likelihood that one party's changes may be lost and omitted from the final document. However, advantageously, the method 500 avoids these problems by maintaining a single, centralized instance of the document, and ensuring that all modifications are made to the single instance of the document.

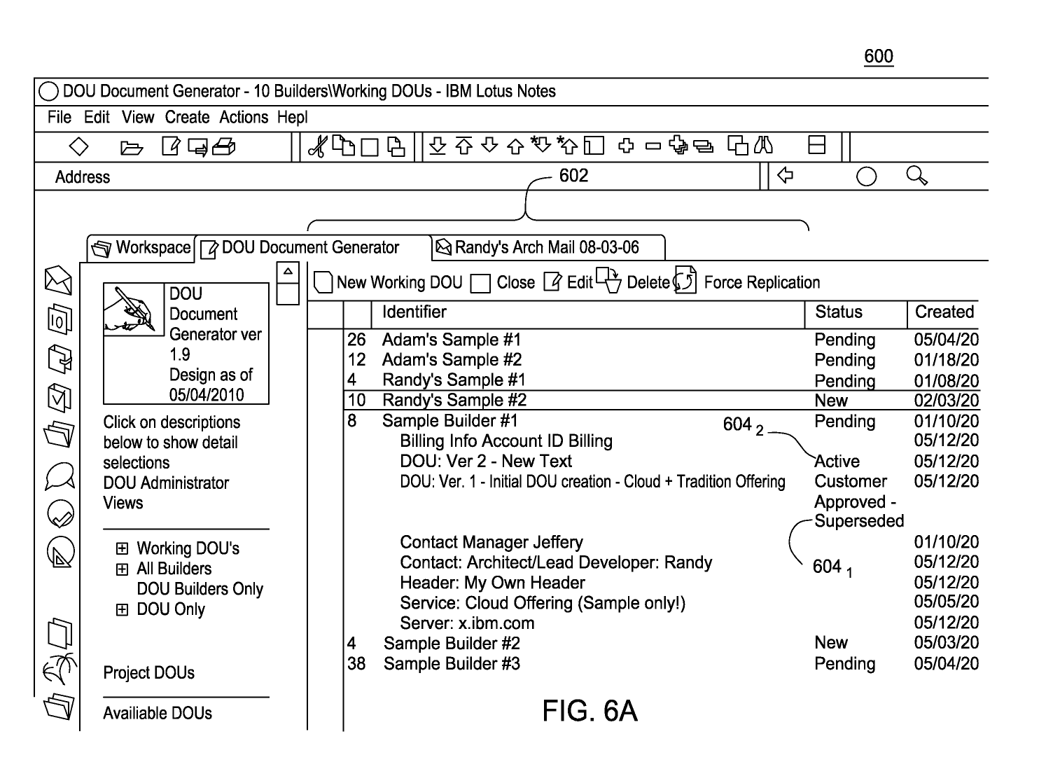

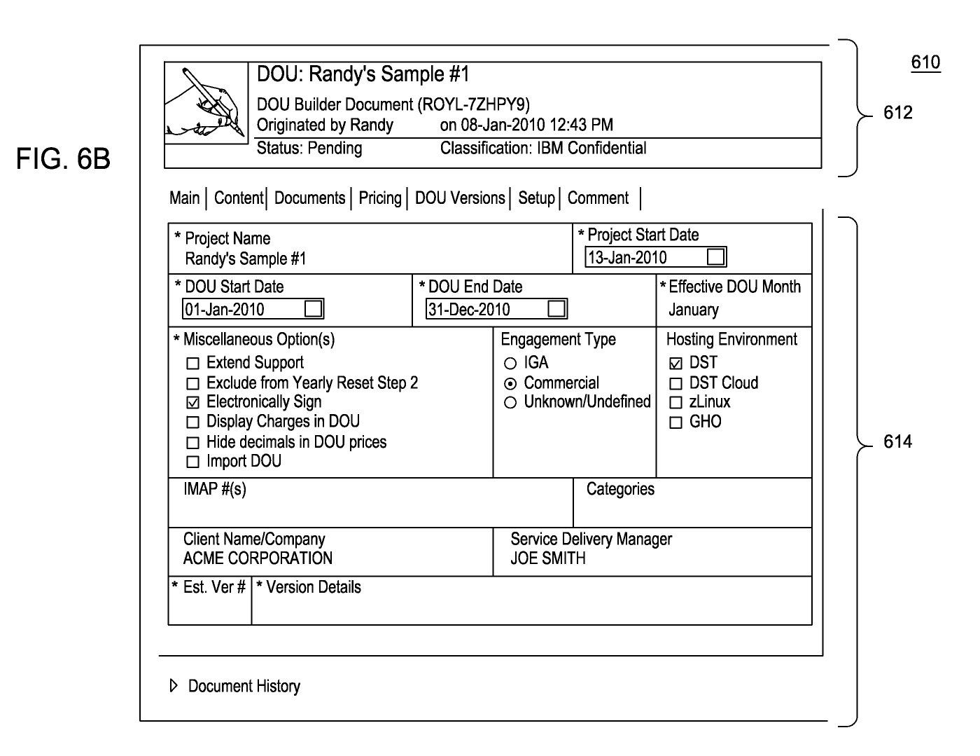

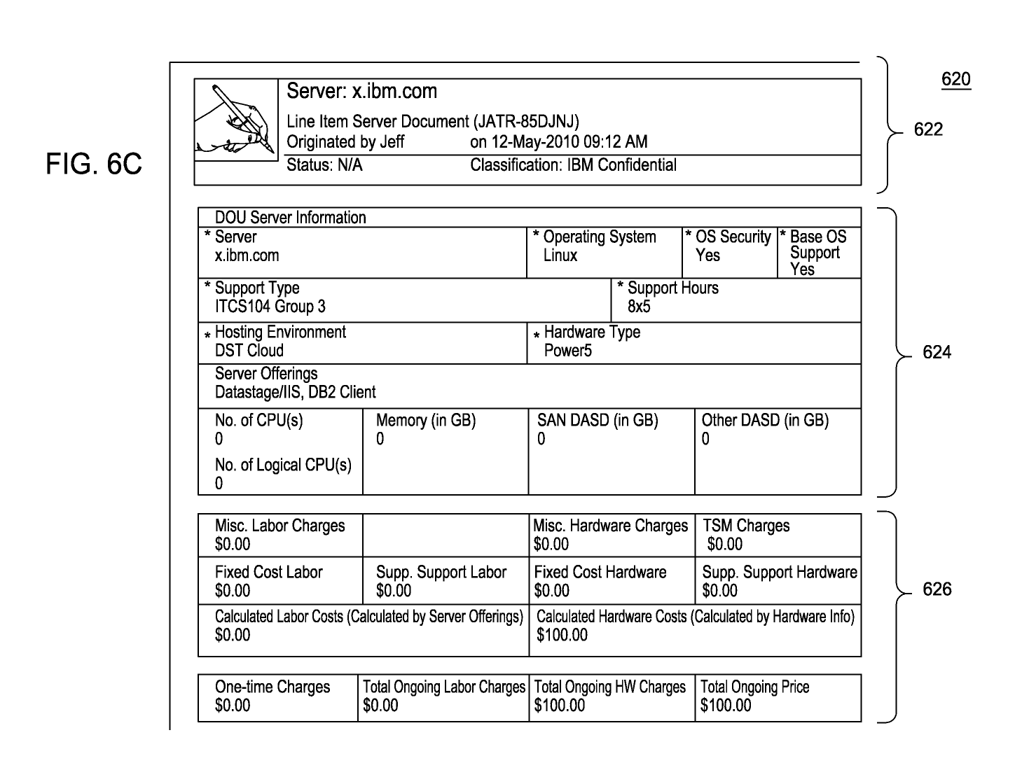

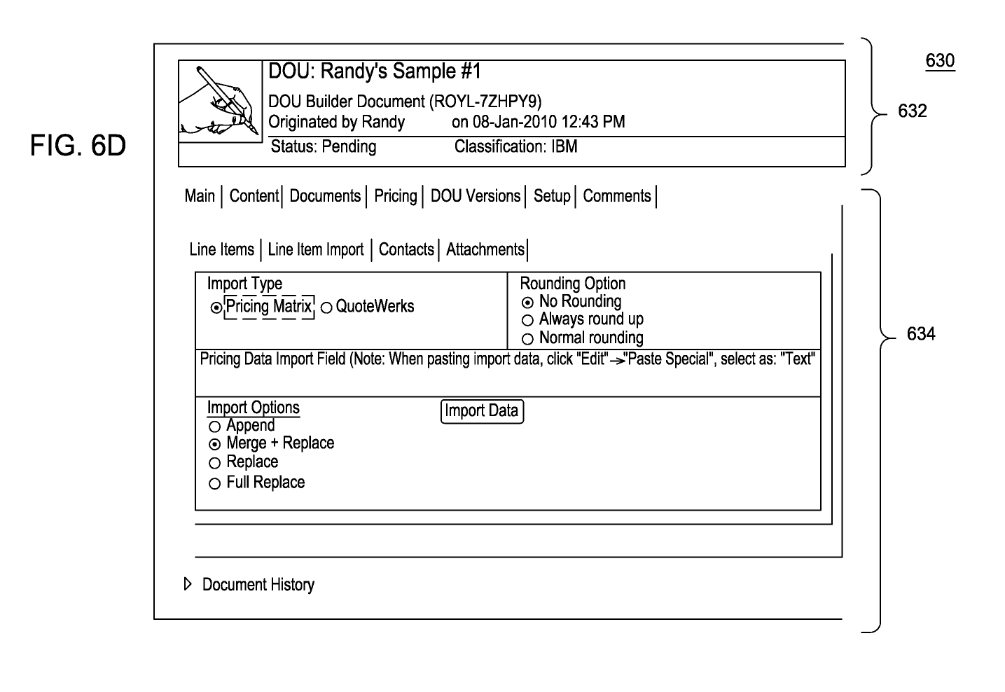

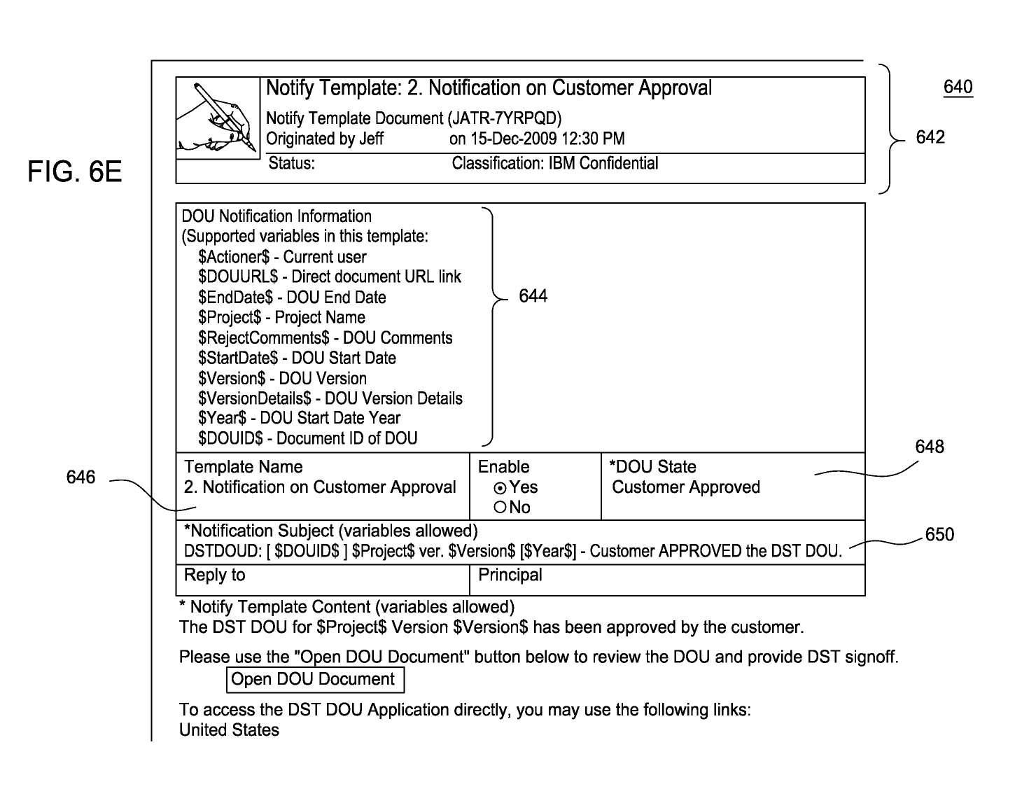

FIGS. 6A-6F are screenshots of an exemplary document creation component, according to embodiments of the present invention. For the purposes of these examples, assume that the document creation component 245 is used to create documents of understanding for service agreements between a business and a customer of the business. More specifically, FIG. 6A is a screenshot of an exemplary document selection screen of a document creation component, according to one embodiment of the present invention. As shown, the screenshot 600 includes a plurality of document creation tools 602. In the depicted example, the document creation tools 602 allow a user to create new documents of understanding, edit existing documents of understanding, delete existing documents of understanding, and so on.

Additionally, the screenshot 600 includes two existing documents of understanding 604₁ and 604₂. As shown, the currently active document of understanding between the business and the customer is the document 604₂ with Identifier “DOU: Ver. 2—New Text” and with Status “Active.” As such, the document 604₂ represents a document of understanding created using the document creation component 245 and because the document 604₂ has been approved by both the customer and the business, the document 604₂ is marked as “Active.” For example, the document 604₂ may have been created using the method 400, and submitted to the customer and approved using the method 500. In this example, the other document 604₁ shown, with Identifier “DOU: Ver. 1—Initial DOU creation—Cloud+Traditional Offering” and Status “Customer Approved—Superseded,” represents a previously active document of understanding that was replaced upon the approval of the document 604₂. Thus, because only a single document of understanding may govern a particular service agreement at a time, when the second document 604₂ was approved, the second document 604₂ superseded the first document 604₁.

FIG. 6B is a screenshot of an exemplary overview page of a particular document in a document creation component, according to one embodiment of the present invention. As shown, the screenshot 610 includes a header portion 612 and a settings portion 614. The header portion generally contains metadata about the document. For example, in the depicted embodiment, the header portion 612 contains information such as the name of the document (i.e., “DOU: Randy's Sample #1”), the creator of the document (i.e., “Randy”), and a date of creation for the document (i.e., “08-Jan-2010 12:43 PM”). The settings portion 614 contains general settings information for the particular document. For example, the settings portion specifies a date the project begins (i.e., “01-Jan-2010”), a date the project ends (i.e., “31-Dec-2010”), a technique for approving the document (i.e., “Electronically Sign”), and a name of the customer in the service agreement associated with the document (i.e., “ACME Corporation”). According to embodiments of the invention, a document administrator may use the overview page of the document creation component 245 to specify general information about a particular document of understanding.

FIG. 6C is a screenshot of an exemplary server component, according to one embodiment of the present invention. As discussed above, a server component 325 is a component 120 that may be added to an initial document 250 to specify particular hardware used in a document of understanding. For example, for a service agreement where the business provides web hosting and database access to the customer, a server component 325 may be added to the document of understanding to specify the server hardware that will be used to host the web and database applications. As shown, the screenshot 620 includes a header portion 622, a server information portion 624, and a server pricing portion 626. The header portion 622 includes metadata about the server component 325, such as the name of the server component (i.e., “x.ibm.com”), the creator of the server component (i.e., “Jeff”), and so on.

The server information portion 624 generally contains details about a particular server. For example, in the depicted embodiment, the server information portion 624 contains a name of the server (i.e., “x.ibm.com”), an operating system for the server (i.e., “Linux”), and a type of hardware for the server (i.e., “Power5”). Additionally, as shown, the server information portion 624 also contains a list of services provided by the server (i.e., “Datastage/IIS, DB2 Client”). The screenshot 620 also includes a server pricing portion 626, which generally contains information specifying the costs associated with the server. Additionally, in one embodiment of the invention, the presented data may be formatted using one or more table templates 360. Of course, the depicted embodiment is for illustrative purposes only, and is not intended to limit the present invention. To that end, one of ordinary skill in the art will quickly recognize that all manner of user interfaces may be used to display and any type of server information may be contained in a server component 325, according to embodiments of the invention.

FIG. 6D illustrates an exemplary data import page of a document creation component, according to one embodiment of the invention. Generally, the data import page is used by the document creation component 245 to import data from an external data source. For example, in one embodiment, the document creation component 245 may import data (e.g., up-to-date pricing data) from an external database. As shown, the screenshot 630 includes a header portion 632 and an import configuration portion 634. As discussed above, the header portion 632 generally contains metadata describing the associated document of understanding.

The import configuration portion 632 of the screenshot 630 includes a number of different settings for importing the data. For instance, the import configuration portion 632 includes an import type, rounding options for rounding the imported data, and an import conflict option (i.e., “Append,” “Merge+Replace,” “Replace,” “Full Replace”). For example, in one embodiment, the document creation component 245 may be configured to import data from two or more external sources. In such a scenario, the document administrator may specify an action to be taken in the event that particular imported data records conflict with one another. For example, the document creation component 245 may be configured to always give preference to a particular external data source, and to always replace conflicting existing values when importing from the particular external data source (e.g., using the “Replace” option). Of course, the depicted data import page is for illustrative purposes only, and one of ordinary skill in the art will recognize that any interface capable of performing the functions described herein may be used.

FIG. 6E illustrates an exemplary notification template of a document creation component, according to one embodiment of the invention. As shown, the screenshot 640 includes a header portion 642, which generally includes metadata describing the notification template. Additionally, the screenshot 640 includes a notification information portion 644, which contains a listing of variables that may be used in the notification. The variables are generic entities that may be populated with document-specific information when a notification is generated using the notification template. The screenshot 640 also includes a name 646 for the notification template, a current state 648 of the document of understanding associated with the notification template (i.e., “Customer Approved”), and a Subject Line 650 for notifications generated using the template. In the depicted embodiment, the subject line 650 includes a plurality of different variables, which will be populated with information when a notification is generated using the template. Advantageously, embodiments provide a more efficient approval process for created documents of understanding by allowing the use of variables in the subject line of the notification. That is, because the notification templates 355 may be reused across multiple different projects and service agreements, document administrator may save the time and effort of recreating the notifications for each separate project and service agreement.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A computer-implemented method for creating a document, comprising:
providing an interface allowing a user to select from a plurality of component documents, wherein each component document defines an attribute of the document;
receiving a selection of one or more component documents from the plurality of component documents;
generating the document, by operation of one or more computer processors, based at least in part on the received selection of one or more component documents, wherein the document defines an agreement between two entities, and wherein the agreement will go into effect when the document is approved;
submitting the generated document for approval; and
upon approval of the submitted document, marking the document as active to indicate the agreement is in effect.

2. The method of claim 1, wherein the plurality of component documents includes at least one build component and one utility component, and wherein receiving a selection of one or more component documents further comprises:
receiving a first selection of at least one build component from the plurality of component documents, wherein the build component defines a portion of the document;
receiving a second selection of at least one utility component from the plurality of component documents, wherein the utility component defines a structure of at least a portion of the document, and
wherein generating the document is further based on at least one of the first selection of at least one build component and the second selection of at least one utility component.

3. The method of claim 1, further comprising:
upon rejection of the submitted document:
modifying at least one of the selected one or more component documents in the received selection; and
generating a second version of the document, based on the modified at least one of the selected one or more component documents.

4. The method of claim 3, further comprising:
submitting the second version of the document for approval; and
upon approval of the second version of the document, marking the second version of the document as active.

5. The method of claim 1, further comprising:
generating a notification, based on an occurrence at least one of (i) approval of the document, (ii) rejection of the document, (iii) cancellation of the document, (iv) submitting the document for approval, and (v) marking the document as active.

6. The method of claim 1, wherein submitting the generated document for approval further comprises:
submitting a reference to the generated document, wherein the reference specifies a location of the generated document.

7. The method of claim 1, further comprising:
retrieving data from a data source, wherein generating the document is further based on the retrieved data.

8. A system, comprising:
a computer processor; and
a memory containing a program that, when executed by the computer processor, performs an operation for creating a document, comprising:
providing an interface allowing a user to select from a plurality of component documents, wherein each component document defines an attribute of the document;
receiving a selection of one or more component documents from the plurality of component documents;
generating the document, based at least in part on the received selection of one or more component documents, wherein the document defines an agreement between two entities, and wherein the agreement will go into effect when the document is approved;
submitting the generated document for approval; and
upon approval of the submitted document, marking the document as active to indicate the agreement is in effect.

9. The system of claim 8, wherein the plurality of component documents includes at least one build component and one utility component, and wherein receiving a selection of one or more component documents further comprises:
receiving a first selection of at least one build component from the plurality of component documents, wherein the build component defines a portion of the document;
receiving a second selection of at least one utility component from the plurality of component documents, wherein the utility component defines a structure of at least a portion of the document, and
wherein generating the document is further based on at least one of the first selection of at least one build component and the second selection of at least one utility component.

10. The system of claim 8, the operation further comprising:
upon rejection of the submitted document:
modifying at least one of the selected one or more component documents in the received selection; and
generating a second version of the document, based on the modified at least one of the selected one or more component documents.

11. The system of claim 10, the operation further comprising:
submitting the second version of the document for approval; and
upon approval of the second version of the document, marking the second version of the document as active.

12. The system of claim 8, the operation further comprising:
generating a notification, based on an occurrence at least one of (i) approval of the document, (ii) rejection of the document, (iii) cancellation of the document, (iv) submitting the document for approval, and (v) marking the document as active.

13. The system of claim 8, wherein submitting the generated document for approval further comprises:
submitting a reference to the generated document, wherein the reference specifies a location of the generated document.

14. The system of claim 8, the operation further comprising:
retrieving data from a data source, wherein generating the document is further based on the retrieved data.

15. A computer program product for creating a document, comprising:
a computer-readable storage medium having computer readable program code embodied therewith, the computer readable program code comprising:
computer readable program code to provide an interface allowing a user to select from a plurality of component documents, wherein each component document defines an attribute of the document;
computer readable program code to receive a selection of one or more component documents from the plurality of component documents;
computer readable program code to generate the document, at least in part on the received selection of one or more component documents, wherein the document defines an agreement between two entities, and wherein the agreement will go into effect when the document is approved;
computer readable program code to submit the generated document for approval; and
computer readable program code to, upon approval of the submitted document, mark the document as active to indicate the agreement is in effect.

16. The computer program product of claim 15, wherein the plurality of component documents includes at least one build component and one utility component, and wherein the computer readable program code to receive a selection of one or more component documents further comprises:
computer readable program code to receive a first selection of at least one build component from the plurality of component documents, wherein the build component defines a portion of the document;
computer readable program code to receive a second selection of at least one utility component from the plurality of component documents, wherein the utility component defines a structure of at least a portion of the document, and
wherein the computer readable program code to generate the document is further based on at least one of the first selection of at least one build component and the second selection of at least one utility component.

17. The computer program product of claim 15, further comprising:
computer readable program code to, upon rejection of the submitted document:
modify at least one of the selected one or more component documents in the received selection; and
generate a second version of the document, based on the modified at least one of the selected one or more component documents.

18. The computer program product of claim 17, further comprising:
computer readable program code to submit the second version of the document for approval; and
computer readable program code to, upon approval of the second version of the document, mark the second version of the document as active.

19. The computer program product of claim 15, further comprising:
computer readable program code to generate a notification, based on an occurrence at least one of (i) approval of the document, (ii) rejection of the document, (iii) cancellation of the document, (iv) submitting the document for approval, and (v) marking the document as active.

20. The computer program product of claim 15, wherein the computer readable program code to submit the generated document for approval, further comprises:
computer readable program code to submit a reference to the generated document, wherein the reference specifies a location of the generated document.
